(19) United States
(12) Patent Application Publication
(10) Pub. No.: US 2024/0338856 A1
(43) Pub. Date: Oct. 10, 2024

(54) Systems and Methods for Reducing Asset Decompression Time

(71) Applicant: Six Impossible Things Before Breakfast Limited, Dublin (IE)

(72) Inventor: Sherry IGNATCHENKO, Weidling (AT)

(73) Assignee: Six Impossible Things Before Breakfast Limited, Dublin (IE)

(21) Appl. No.: 18/630,605

(22) Filed: Apr. 9, 2024

Related U.S. Application Data
(60) Provisional application No. 63/495,207, filed on Apr. 10, 2023.

(51) Int. Cl. G06T 9/00; A63F 13/60

(52) U.S. Cl. CPC G06T 9/00; A63F 13/60; A63F 2300/60

(57) ABSTRACT

Systems and methods for reducing asset size and loading time of digital assets are disclosed herein. Asset sizes and load times may be reduced by storing images in a decompression-friendly format and/or by performing hybrid decompression of compressed images using both a central processing unit (CPU) and a graphics processing unit (GPU). Such hybrid decompression may be performed on an image compressed using discrete cosine transform (DCT)-based compression. The CPU may be configured to decompress a compressed image using an entropy decoding method. DCT coefficients may then be passed to the GPU for further DCT processing. The GPU may be configured to recompress the decompressed image and write the recompressed image directly to a texture memory of the GPU (i.e., without providing the recompressed image to the CPU).

### RELATED APPLICATIONS

This application claims priority to U.S. Provisional Application No. 63/495,207, entitled “Method for Reducing Asset Sizes and Load Times,” filed on Apr. 10, 2023, the content of which is hereby incorporated herein by reference in its entirety.

### FIELD OF THE DISCLOSURE

The systems and methods described herein relate to improved techniques for rendering computer-generated three-dimensional models for video games.

### BACKGROUND

In computer graphics, graphics processing units (GPUs) are frequently used to process and render computer-generated three-dimensional models. While central processing units (CPUs) are designed to excel at executing a sequence of operations as fast as possible, GPUs are designed to excel at executing hundreds or thousands of operations in parallel. As GPUs primarily rely on thread-level parallelism to maximize utilization of those functional units, a hybrid system utilizing both a CPU and a GPU may achieve higher performance with optimal instruction throughput and memory bandwidth as compared to using a system with a CPU alone.

In three-dimensional game applications, applications typically include a mix of parallel tasks/operations and sequential tasks/operations. With the hybrid compression/decompression using the CPU and the GPU, the hybrid computer system may be configured to strategically allocate the responsibility of those tasks/operations, for example, recompressing a decompressed image into a decompression-friendly formats and/or reducing the game asset size, so that the compression/decompression algorithm may operate more efficiently, thereby improving loading time of the game assets. As such, there is a need in the art for an improved hybrid system using GPUs and CPUs to improve an asset size and loading time of the digital assets.

### SUMMARY OF THE DISCLOSURE

This disclosure relates to systems and methods for reducing asset size and loading time of digital assets by compressing images in a decompression-friendly format and/or performing hybrid decompression of compressed images using both a central processing unit (CPU) and a graphics processing unit (GPU).

According to one aspect of the invention, images are compressed in a decompression-friendly format in order to reduce the asset size and load time of digital assets. In various implementations, such images may be compressed using discrete cosine transform (DCT)-based compression. In some implementations, in order to compress an image in a decompression-friendly format, the image may be compressed without using progressive encoding, using XYB as a color space, using Chroma-from-Luma prediction, and/or using Var-DCT mode only. In some implementations, the compressed image may be provided for download as part of a downloadable resource providing a game asset, in which the downloadable resource comprises interleaved streams for each of glTF JSON data, a mesh, and a texture of the game asset.

According to another aspect of the invention, a client computer system may be configured to utilize both a central processing unit (CPU) and a graphics processing unit (GPU) to perform hybrid decompression of a texture or other image associated with a digital asset. In various implementations, such hybrid decompression may be performed on an image compressed using discrete cosine transform (DCT)-based compression. In various implementations, the CPU may be configured to decompress a compressed image using an entropy decoding method. For example, the entropy decoding method may comprise Huffman decoding, asymmetrical numeral systems (ANS) decoding, and/or other entropy decoding methods. In various implementations, decompressed DCT coefficients may then be passed to the GPU for further DCT processing. In various implementations, the GPU may be configured to recompress the decompressed image, for example, into a DXT1, DXT5, ETC1, ETC2, or other similar format. In various implementations, the decompressed image may be recompressed using blocks the same size or a multiple of the size of the original DCT blocks. In various implementations, the GPU may write the recompressed image directly to a texture memory of the GPU (i.e., without providing the recompressed image to the CPU). In various implementations, a game asset may be rendered, by the GPU, using the recompressed image written to the texture memory of the GPU.

In various implementations, a client computer system may include at least one other graphics processing unit (GPU). When two such graphics cards are installed in the client computer system and available for rendering the digital assets, a first GPU may be an internal GPU and the second GPU may be a discrete GPU. In such implementations, one GPU may be configured to facilitate hybrid decompression, as described herein, and the other GPU may be configured to render assets within a virtual scene of, for example, an online game.

In some implementations, a client computer system may determine whether to use a CPU or a combination of a CPU and GPU to decompress and recompress images. To determine whether to use the CPU or a combination of the CPU and GPU, characteristics of a loading queue associated with a digital asset (or game asset) may be measured (e.g., by CPU) and whether to recompress a decompressed second image on the CPU or the GPU may be determined based on the measured characteristics of the loading queue.

These and other objects, features, and characteristics of the systems and/or methods disclosed herein, as well as the methods of operation and functions of the related elements of structure and the combination thereof, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

The present invention is illustrated by way of example and not limited in the accompanying figures in which like reference numerals indicate similar elements and in which:

FIG. 1 depicts a block diagram of an example of a system configured to reduce asset size and load time by saving digital assets in a decompression-friendly format and/or performing hybrid decompression using a CPU and a GPU, according to one or more aspects described herein; and

FIG. 2 depicts a flow diagram of an example of a method for performing hybrid decompression of digital assets used to render a virtual scene within an online game, according to one or more aspects described herein.

These drawings are provided for purposes of illustration only and merely depict typical or example embodiments. These drawings are provided to facilitate the reader's understanding and shall not be considered limiting of the breadth, scope, or applicability of the disclosure. For clarity and ease of illustration, these drawings are not necessarily drawn to scale.

### DETAILED DESCRIPTION

Certain illustrative aspects of the systems and methods according to the present invention are described herein in connection with the following description and the accompanying figures. These aspects are indicative, however, of but a few of the various ways in which the principles of the invention may be employed and the present invention is intended to include all such aspects and their equivalents. Other advantages and novel features of the invention may become apparent from the following detailed description when considered in conjunction with the figures.

In the following detailed description, numerous specific details are set forth in order to provide a thorough understanding of the invention. In other instances, well known structures, interfaces, and processes have not been shown in detail in order not to unnecessarily obscure the invention. However, it will be apparent to one of ordinary skill in the art that those specific details disclosed herein need not be used to practice the invention and do not represent a limitation on the scope of the invention, except as recited in the claims. It is intended that no part of this specification be construed to effect a disavowal of any part of the full scope of the invention. Although certain embodiments of the present disclosure are described, these embodiments likewise are not intended to limit the full scope of the invention.

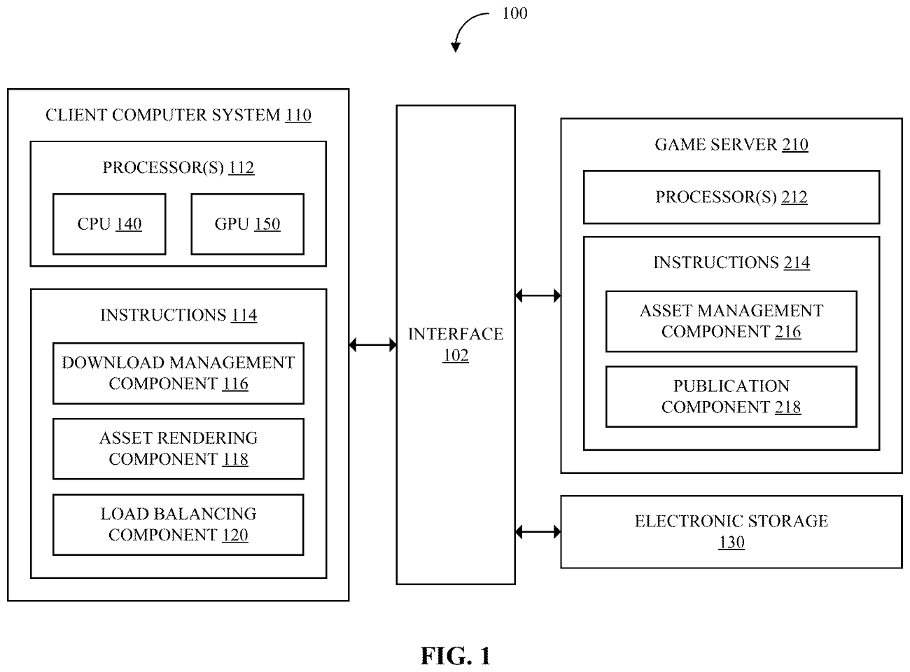

FIG. 1 illustrates an example of a system 100 for reducing asset size and load time by saving assets in a decompression-friendly format and/or performing hybrid decompression using a CPU and a GPU, according to one or more aspects described herein. In various implementations, system 100 may include one or more of an interface 102, at least one client computer system 110, electronic storage 130, a game server 210, and/or other components. In various implementations, client computer system (or device) 110 may comprise a game client computing system (or device). In some implementations, client computer system 110 may be configured to receive instructions and game state data related to an online game comprising three-dimensional virtual scenes from game server 210. In various implementations, client computer system 110 may include one or more physical processors 112 (also interchangeably referred to herein as processor(s) 112, processor 112, or processors 112 for convenience), computer readable instructions 114, and/or one or more other components. In various implementations, game server 210 may include one or more physical processors 212 (also interchangeably referred to herein as processor(s) 212, processor 212, or processors 212 for convenience), computer readable instructions 214, and/or one or more other components. In some implementations, system 100 may include one or more external resources, such as sources of information outside of system 100, external entities participating with system 100, and/or other resources. In various implementations, system 100 may be configured to receive input from or otherwise interact with one or more users via client computer system 110 and/or game server 210.

In various implementations, processor(s) 112, 212 may be configured to provide information processing capabilities in system 100. As such, the processor(s) 112, 212 may comprise one or more of a digital processor, an analog processor, a digital circuit designed to process information, a central processing unit, a graphics processing unit, a microcontroller, a microprocessor, a field programmable gate array (FPGA), an application specific integrated circuit (ASIC), a System on a Chip (SoC), and/or other mechanisms for electronically processing information. Processor(s) 112, 212 may be configured to execute one or more computer readable instructions 114, 214. Computer readable instructions 114, 214 may include one or more computer program components. In various implementations, computer readable instructions 114 may include one or more of download management component 116, asset rendering component 118, load balancing component 120, and/or one or more other computer program components, and computer readable instructions 214 may include one or more of asset management component 216, publication component 218, and/or other computer program components. As used herein, for convenience, the various computer readable instructions 114, 214 will be described as performing an operation, when, in fact, the various instructions program the processor(s) 112, 212 (and therefore client computer system 110 or game server 210) to perform the operation. As described herein, in some implementations, the processors 112 may include at least a central processing unit (CPU) 140 and a graphics processing unit (GPU) 150 configured to perform hybrid processing of textures or other images associated with a digital asset. In such implementations, the CPU 140 may comprise one or more of a digital processor, an analog processor, a digital circuit designed to process information, a central processing unit, a graphics processing unit, a microcontroller, a microprocessor, a field programmable gate array (FPGA), an application specific integrated circuit (ASIC), a System on a Chip (SoC), and/or other mechanisms for electronically processing information. The GPU 150, on the other hand, may comprise a graphics processing unit.

In various implementations, client computer systems 110 may subscribe to receive game updates from a game server 210 related to an online game. For example, game server 210 may “publish” game state, and one or more of client computer system 110 may “subscribe” to receive the published game state. As a result of such a “subscription” by a client computer system 110, game server 210 may (a) send client computer system 110 a current game state, (b) include client computer system 110 (identified, for example, by its IP address and/or network socket which is used to communicate with client computer system 110) on a list of “subscribers” for this “publication”, and (c) whenever published game state is updated (for example, as a result of user inputs sent to the game server and/or as a result of simulation), game server 210 may send the update to the game state to all the current “subscribers.” In response to the updated game state data and/or as otherwise necessary, client computing system 110 may be configured to download game assets from game server 210 for rendering within virtual scenes of the game. To that end, in various implementations, asset management component 216 may be configured to generate, organize, encode, and/or otherwise manage game assets used to render a virtual scene. For example, game assets may comprise the three-dimensional objects that, when rendered, make up a virtual scene in a game.

In various implementations, asset management component 216 may be configured to save digital assets. For example, to do so, in various implementations, asset management component 216 may be configured to utilize any of the one or more compression methods described in U.S. patent application Ser. No. 18/630,409, entitled “SYSTEMS AND METHODS FOR INCREMENTAL DYNAMIC LOADING OF GAME ASSETS,” filed Apr. 9, 2024, the contents of which are hereby incorporated by reference herein in their entirety. In some implementations, asset management component 216 may be configured to utilize any of the one or more compression methods described in U.S. patent application Ser. No. 18/630,409, with minor modifications. In various implementations, asset management component 216 may be configured to save digital assets in a “decompression-friendly” format. For example, when compressing a texture, the “decompression-friendly” format may comprise a modified version of JPEG or JPEG XL format (or any other format from the JPEG family), as described below.

In various implementations, when textures of a digital asset are compressed using JPEG as a base format, asset management component 216 may be configured to perform one or more operations described further in this paragraph to modify the compression of such textures. In some implementations, asset management component 216 may be configured to avoid using progressive encoding. In some implementations, asset management component 216 may be configured to avoid using Huffman coding or other arithmetic coding methods, which are typically used in JPEG. For example, asset management component 216 may be configured to instead use a different entropy coding method, such as one of the asymmetric numeral systems (ANS) family of entropy coding methods, to compress DC and/or AC coefficients. Using one of the asymmetric numeral systems (ANS) family of entropy coding methods instead of Huffman coding alone may lead to compression gains of about 20-30% without affecting decompression speeds. As referred to herein, the ANS family of entropy coding methods may include range asymmetric numeral systems (rANS), tabled asymmetrical numeral systems (tANS), finite state entropy (FSE), and/or one or more other similar entropy coding methods. In some implementations, asset management component 216 may be configured to use XYB as a color space (as opposed to using Y′CbCr color space, which is typically used by JPEG) and/or Chroma-from-Luma prediction (e.g., as described in the draft International Standard document titled “JPEG XL Image Coding System” (dated Aug. 5, 2019), available at https://arxiv.org/pdf/1908.03565.pdf).

In various implementations, when textures of a digital asset are compressed using JPEG XL as a base format, asset management component 216 may be configured to perform one or more operations described further in this paragraph to modify the compression of such textures. In some implementations, asset management component 216 may be configured to avoid using progressive encoding. In some implementations, asset management component 216 may be configured to selectively choose (or restrict) compression to Var-DCT (or variable-blocksize DCT) mode only. In some implementations, asset management component 216 may be configured to selectively choose (or restrict) a maximum size of DCT blocks to a smaller size (e.g., such as an 8×8 block, a 16×16 block, or a 32×32 block). Other smaller than standard size blocks may be used as would be understood by a person of ordinary skill in the art. Maintaining a smaller DCT block size may help to decompress faster, especially on a GPU. In some implementations, asset management component 216 may be configured to use loop filters, always filling with zeros. In some implementations, asset management component 216 may be configured to avoid using additional features of the JPEG XL format.

In some implementations, the process of making a format “decompression-friendly” may be generalized to other formats based on two-dimensional (2D) frequency-domain transform (such as DCT, Fast Fourier Transform (FFT), or Walsh-Hadamard Transform (WHT)). Such formats include AVIF, WebP, and/or other compression formats (including custom formats). In general, to make a format “decompression-friendly”, it may be desirable to make all the processing that happens during decompression, after decoding a 2D frequency-domain block (such as 8×8 DCT block for JPEG format), independent from information in other frequency-domain blocks. In other words, after a decoder (or decoding method) processes a frequency-domain block, it should not need any information from other blocks to obtain pixels of the final image. Doing so may facilitate hybrid decompression as described herein.

In various implementations, when meshes of a digital asset are compressed, asset management component 216 may be configured to save (or compress/encode) the mesh using one or more techniques described in U.S. patent application Ser. No. 18/438,702, entitled “SYSTEMS AND METHODS FOR IMPROVING COMPRESSION OF STRUCTURED DATA IN THREE-DIMENSIONAL APPLICATIONS,” filed Feb. 12, 2024, U.S. patent application Ser. No. 18/438,898, entitled “SYSTEMS AND METHODS FOR PERFORMING PROGRESSIVE MESH COMPRESSION,” filed Feb. 12, 2024, and/or U.S. patent application Ser. No. 18/630,409, entitled “SYSTEMS AND METHODS FOR INCREMENTAL DYNAMIC LOADING OF GAME ASSETS,” filed Apr. 9, 2024, the contents of each of which are hereby incorporated by reference herein in their entirety. In various implementations, asset management component 216 may be configured to use rANS or tANS to encode glTF JSON, but only with parallelogram prediction algorithms. In various implementations, asset management component 216 may be configured to encode or save several different types of assets (e.g., glTF JSON, mesh, and textures belonging to the same three-dimensional object) in the same file. In some implementations, if level of details (LODs) are used, glTF JSON, mesh, and/or textures of the digital asset may be stored in a file in an interleaved manner. For example, streams for different types of assets (e.g., glTF JSON, mesh, and textures belonging to the same three-dimensional object) may be interleaved as described in U.S. patent application Ser. No. 18/630,409, which allows assets of the same LOD to be located next to each other in the same stream. Storing assets in an interleaved manner may help improve loading time over the network and/or read time from solid-state drives (SSDs).

In various implementations, publication component 218 may be configured to publish data regarding a current state of the game. For example, in various implementations, a publication may include a current level, list of items and/or non-player characters (NPCs) with identifiers for their three-dimensional models and/or their coordinates. In various implementations, client computer system 110 may be configured to request digital assets (which may be interchangeably referred to herein as “game assets”) from game server 210, which may be provided in the form of downloadable resources. In some implementations, client computer system 110 may be configured to request and download said digital assets in response to receiving a publication from the game server 210 indicating at least a current state of a game. In some implementations, client computer system 110 may be configured to load digital assets directly from storage accessible by client computer system 110 (i.e., without having to request digital assets from game server 210). In either case, digital assets to be loaded by client computer system 110 may be stored by game server 210 (and available for request by client computer system 110) and/or stored in electronic storage accessibly by client computer system 110, and such digital assets may be compressed and stored according to the one or more techniques described herein.

When loading digital assets compressed and stored using the one or more techniques described herein, client computer system 110 may be configured to perform one or more operations described further in this paragraph. For example, when loading a texture stored in a decompression-friendly format, download management component 116 of client computer system 110 may be configured to read the resource from storage (such as NAND flash memory, a solid-state drive (SSD), a Secure Digital (SD) card, and/or other storage medium) and decompress the resource using traditional decompression methods, albeit relying on restrictions described herein). In some implementations, download management component 116 may be configured to recompress texture data into a GPU-friendly format (such as DXT1, DXT5, ETC2, and/or other similar formats) and feed the resulting recompressed texture data to a GPU (e.g., GPU 150) for rendering.

In various implementations, download management component 116 may be configured to facilitate hybrid decompression using a CPU and a GPU. In some implementations, download management component 116 may be configured to decompress textures of game assets on CPU 140. For example, download management component 116 may be configured to decompress textures on CPU 140 using traditional decompression methods, such as a reference JPEG or JPEG XL decoding method. In other implementations, and as described herein, download management component 116 may be configured to decompress textures by performing operations on both CPU 140 and GPU 150. In such implementations, download management component 116 may comprise instructions described herein as being performed by (or programming) CPU 140 and GPU 150. However, it is to be understood that CPU 140 and GPU 150 are configured by computer readable instructions (e.g., download management component 116 and/or one or more other instructions/components described herein) to perform the various operations described herein.

In various implementations, CPU 140 may be configured to perform initial processing operations on digital assets (or a texture of a digital asset) to be decompressed. For example, when decompressing a texture compressed using one or more of the techniques described herein, the texture may be compressed using JPEG or JPEG XL as a base format. When decompressing such a texture, CPU 140 may be configured to parse an input JPEG stream and/or JPEG XL frames. In various implementations, CPU 140 may be configured to decompress the texture using at least one entropy decoding method. For example, the at least one entropy decoding method may comprise Huffman coding, arithmetic coding, one of the asymmetric numeral systems (ANS) family of entropy coding methods, and/or one or more other entropy coding methods. In various implementations, CPU 140 may be configured to split the input stream into DCT block-specific parts before passing the parts of the stream to GPU 150.

In some implementations, CPU 140 may be configured to pass the decompressed coefficients of each of the DCT blocks to the GPU 150. In some implementations, the decompressed coefficients may include both DC coefficients and AC coefficients. In some implementations, CPU 140 may be configured to pass the decompressed coefficients and data associated with a prediction pertaining to each of the DCT blocks to GPU 150.

When CPU 140 passes the decompressed coefficients and other information to GPU 150, the information may be in smaller unrelated chunks. For example, when feeding DCT coefficients (with or without data associated with prediction), information necessary to run prediction and reconstruct samples may be included with each smaller chunk. These unrelated chunks may then be run completely independently on GPU 150, allowing most or all of the cores of GPU 150 to be used without spending time on synchronization. For example, when decompressing a 1024×1024 pixel texture, which is split into 8×8 DCT blocks, CPU 140 may be configured to pass 16,384 chunks of 8×8 DCT blocks (i.e., 1024×1024/8/8=16384 chunks) to GPU 150, which may be more than the number of available cores in GPU 150, thus ensuring that all cores of GPU 150 are utilized.

In various implementations, GPU 150 may be configured to run a program (i.e., a set of computer-readable instructions) to perform the operations described herein. In some implementations, GPU 150 may be configured to run a program using General-Purpose Graphics Processing Unit (GPGPU) kernels, such as Compute Unified Device Architecture (CUDA) or Open Computing Language (OpenCL) kernals. CUDA is a parallel computing platform and application programming interface of Nvidia™. OpenCL is an open standard of a framework for writing programs that execute across heterogeneous platforms consisting of central processing units (CPUs), graphics processing units (GPUs), digital signal processors (DSPs), field-programmable gate arrays (FPGAs) and other processors or hardware accelerator.

In various implementations, once CPU 140 passes the decompressed coefficients and other information to GPU 150, GPU 150 may be configured to perform adaptive dequantization (for JPEG XL-based methods) or JPEG dequantization (for JPEG-based methods). In various implementations, JPEG dequantization may include differential pulse-code modulation (DPCM) and/or run-length encoding (RLE). In some implementations, dequantization can be performed on CPU 140, before sending the data to the GPU 150. In some implementations, for JPEG XL-based methods, GPU 150 may be configured to perform Chroma-from-Luma decorrelation. In some implementations, for JPEG XL-based methods, GPU 150 may be configured to perform AC prediction (and add AC predictions to the coefficients). In some implementations, CPU 140 may be configured to perform the operations described in this paragraph before passing the information to GPU 150.

In various implementations, GPU 150 may be configured to perform inverse DCT transformation from coefficients to samples. In some implementations, GPU 150 may be configured to perform a wavelet transform (such as Haar transform) and/or squeeze transform as described in the draft International Standard document titled “JPEG XL Image Coding System” (dated Aug. 5, 2019), available at https://arxiv.org/pdf/1908.03565.pdf. In other implementations, for JPEG XL-based methods, GPU 150 may be configured to run loop filters and/or add image features (such as patches, splines, noise, and other similar primitives). For example, GPU 150 may be configured to add image features as described in “JPEG White Paper: JPEG XL Image Coding System” (Version 2.0), dated January 2023 and available at https://ds.jpeg.org/whitepapers/jpeg-xl-whitepaper.pdf.

In various implementations, GPU 150 may be configured to recompress the texture into a GPU-friendly format (such as, for example, DXT1, DXT5, BC7, BC6H, ETC, ETC2, PVRTC, and/or ASTC). In various implementations, CPU 140 (or client computer system 110) may be configured to select the GPU-friendly format that incudes blocks which have a same size of the DCT blocks provided by CPU 140. In some implementations, GPU 150 (or client computer system 110) may be configured to select the GPU-friendly format that incudes blocks which are a multiple of the DCT blocks provided by CPU 140. In some implementations, GPU 150 (or client computer system 110) may be configured to select the GPU-friendly format for which the DCT blocks provided by CPU 140 are a multiple of. For example, if power-of-two DCT blocks are used, GPU 150 (or client computer system 110) may be configured to select (and utilize) an encoding format which also uses power-of-two blocks, such as 4×4 and 8×8 blocks. Examples of the formats using power-of-two blocks may be DXT1, DXT5, ASTC, ETC1/ETC2, and BC7, which all use 4×4 blocks, or ASTC, which supports using 8×8 blocks (and/or one or more other block sizes). In such implementations, GPU 150 (or client computer system 110) may be configured to avoid using methods that do not use power-of-two blocks, such as ASTC 6×6 or any ASTC method that uses N×M blocks, where N or M is not a power of two. Such methods may not be desirable as using them will break the independence of the processing tasks on GPU 150 and will require passing information between different GPU kernels. In some implementations, GPU 150 may also be configured to generate mipmaps.

In various implementations, GPU 150 may be configured to write the recompressed texture directly to a texture memory of GPU 150. For example, GPU 150 may be configured to write the recompressed texture without providing the recompressed texture to the CPU. In other words, the recompressed texture may stay on GPU 150. For example, if GPU 150 is utilizing CUDA, the recompressed texture may be written using one or mor techniques described in Section 3.2.12.2 (Surface Memory) and/or Section 3.2.13 (Graphics Interoperability) in “CUDA C++ Programming Guide” (last visited Mar. 29, 2024), available at https://docs.nvidia.com/cuda/cuda-c-programming-guide/index.html. If GPU 150 is utilizing OpenCL, the recompressed texture may be written using one or mor techniques described in “Sharing textures in OpenGL/OpenCL” (last visited Mar. 29, 2024), available at http://digital-thinking.de/tutorial-gameoflife-openglopencl/.

In various implementations, asset rendering component 118 may be configured to render a game asset using the recompressed texture stored or written to the texture memory of GPU 150. However, in other implementations, asset rendering component 118 may be configured to render the game asset using a texture stored or written to a texture memory by CPU 140. In various implementations, at least one texture may be decompressed on CPU 140 (e.g., using traditional decompression methods, such as reference JPEG XL decoding methods), and at least one other texture may be decompressed by a combination of CPU 140 and GPU 150 using hybrid decompression, as described herein.

In some implementations, only CPU 140 may be used to decompress a texture (e.g., using traditional decompression methods, such as reference JPEG XL decoding methods). In other implementations, a combination of CPU 140 and GPU 150 may be used to decompress a texture using hybrid decompression, as described herein. In some implementations, hybrid decompression (i.e., using both CPU 140 and GPU 150 to decompress a texture) may only be used when a game is in a “loading level” state. As used herein, a “loading level” state may comprise a state when rendering is not presently happening. In other words, using hybrid decompression may be avoided when a virtual scene within a game is actively being rendered.

In various implementations, instructions 112 of client computer system 110 may include a load balancing component 120 configured to determine whether CPU 140 and/or a combination of CPU 140 and GPU 150 is used to decompress textures. For example, load balancing component 120 may be configured to balance decompression using only CPU 140 and hybrid decompression using both CPU 140 and GPU 150 such that both CPU 140 and GPU 150 are loaded (or actively being utilized). In some implementations, load balancing component 120 may be configured to measure the load of each of CPU 140 and GPU 150. In some implementations, client computer system 110 may have a queue of textures already read from storage and ready to be decompressed. In some implementations, load balancing component 120 may be configured to measure various characteristics of said queue. In some implementations, load balancing component 120 may be configured to manage the balancing of processing between CPU 140 and GPU 150 such that, whenever the decompression of a texture on CPU 140 is completed (and, in some cases, is loaded into GPU 150), CPU 140 may proceed to decompress the next texture from the queue, and whenever the hybrid decompression of a texture using CPU 140 and GPU 150 is completed, the next texture from the queue may begin to be decompressed using hybrid decompression. In this way, both decompressors may be kept fully utilized. In some implementations, decompression using only CPU 140 and hybrid decompression using both CPU 140 and GPU 150 may be run in different threads.

In some implementations, processors 112 of client computer system 110 may include at least a second GPU. When two GPUs are installed in client computer system 110 (and if one GPU is internal and the other discrete), one GPU may be configured to render the game asset, while the other GPU (i.e., GPU 150) may be configured to perform hybrid decompression with CPU 140, as described herein. In such implementations, client computer system 110 may be configured to provide (pass) a decompressed texture of a game asset from GPU 150 to CPU 140, and CPU 140 may then pass the decompressed texture to the other GPU to render the texture with the remainder of a digital asset. In some implementations, where client computer system 110 comprise a second GPU, client computer system 110 may be configured to use hybrid decompression when the game is being played or in any other state other than a “loading level” state.

In some implementations, the one or more techniques described herein may be used for storing and/or decompressing cached assets. For example, one or more techniques described herein may be used when caching downloadable game resources as described, for example, in U.S. patent application Ser. No. 18/630,409.

In embodiments in which a shared memory is utilized between CPU 140 and GPU 150, the shared memory may be utilized to pass textures between CPU 140 and GPU 150 in one or both directions. This, for example, may utilize some techniques which are referred to as “Zero Copy” techniques, such as those described in “Getting the Most from OpenCL™ 1.2: How to Increase Performance by Minimizing Buffer Copies on Intel® Processor Graphics,” by Adam Lake (last visited Apr. 8, 2024), available at https://www.intel.com/content/dam/develop/external/us/en/documents/opencl-zero-copy-in-opencl-1-2.pdf.

In some implementations, especially in those utilizing hybrid decompression, results of calculations from GPU 150 may be passed back to CPU 140. In one non-limiting example, CPU 140 may be configured to process frame parsing and/or entropy decoding, then data from the previous step (e.g., AC/DC coefficients or full DCT matrices) may be passed to GPU 150. Once the data is received by GPU 150, GPU 150 may be configured to perform inverse DCT and maybe some color-space conversions. After DCT, pixel data may be passed back to CPU 140 for further processing, such as JPEG XL feature processing and/or other processing. Afterwards, the texture may be passed back to GPU 150 for rendering.

In some implementations, any other frequency-domain representation of the pixel data (such as 2D Fourier coefficients, or Walsh-Hadamard Transform (WHT) coefficients) may be used in lieu of DCT coefficients. In such implementations, respective inverse conversion may be used in lieu of inverse DCT transform. For example, if 2D Fourier coefficients are used, inverse Fast Fourier Transform (FFT) or inverse WHT may be used.

While various operations are described herein as being performed by the client computer system 110 or the game server 210 (or one or more components of client computer system 110 or game server 210), it is to be understood that, unless explicitly indicated otherwise, each of the one or more operations described herein as being performed by a client computer system 110 could be performed by a game server 210 and that each of the operations described herein as being performed by a game server 210 could be performed by a client computer system 110.

Electronic storage 130 may include electronic storage media that electronically stores and/or transmits information. The electronic storage media of electronic storage 130 may be provided integrally (i.e., substantially nonremovable) with one or more components of system 100 and/or removable storage that is connectable to one or more components of system 100 via, for example, a port (e.g., USB port, a Firewire port, and/or other port) or a drive (e.g., a disk drive and/or other drive). Electronic storage 130 may include one or more of optically readable storage media (e.g., optical disks and/or other optically readable storage media), magnetically readable storage media (e.g., magnetic tape, magnetic hard drive, floppy drive, and/or other magnetically readable storage media), electrical charge-based storage media (e.g., EPROM, EEPROM, RAM, and/or other electrical charge-based storage media), solid-state storage media (e.g., flash drive and/or other solid-state storage media), and/or other electronically readable storage media. Electronic storage 130 may be a separate component within system 100, or electronic storage 130 may be provided integrally with one or more other components of system 100 (e.g., client computer system 110, processor(s) 112, game server 210, and/or other components). Although electronic storage 130 is shown in FIG. 1 as a single entity, this is for illustrative purposes only. In some implementations, electronic storage 130 may comprise a plurality of storage units. These storage units may be physically located within the same device, or electronic storage 130 may represent storage functionality of a plurality of devices operating in coordination.

Electronic storage 130 may store software algorithms, information determined by CPU 140, GPU 150, and/or processor(s) 212, information received remotely, and/or other information that enables system 100 to function properly. For example, electronic storage 130 may store information relating to one or more three-dimensional models, one or more textures, one or more existing compression algorithms to be used to compress a texture, one or more compression/decompression algorithms according to techniques described herein, and/or other information.

Game server 210 may comprise a remote server configured to provide publications and game state data related to an online game comprising three-dimensional virtual scenes to client computer system 110. In some implementations, game server 210 may be configured to provide to client computer system 110 publications related to an online game that include cause three-dimensional object(s) to be rendered within a virtual scene. For example, a publication may cause a virtual scene to be constructed comprising at least one object to be generated based on a generic asset, a base texture, and an assets received in response to a request. In various implementations, game server 210 may be configured as a server device (e.g., having one or more server blades, processors, etc.) and/or as another device capable of providing publications and game state data related to an online game to client computer system 110.

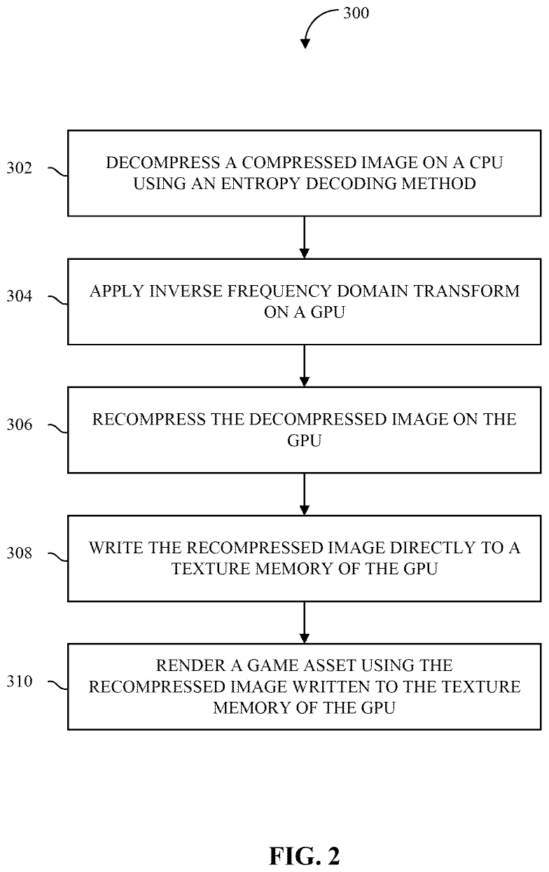

FIG. 2 illustrates an example of a process 300 for performing hybrid decompression of digital assets used to render a virtual scene within an online game, according to one or more aspects described herein. The operations of process 300 presented below are intended to be illustrative and, as such, should not be viewed as limiting. In some implementations, process 300 may be accomplished with one or more additional operations not described, and/or without one or more of the operations discussed. In some implementations, two or more of the operations of process 300 may occur substantially simultaneously. The operations of process 300 may be implemented on a computer system comprising at least a central processing unit (CPU) and a graphics processing unit (GPU). The described operations may be accomplished using some or all of the system components described in detail above.

In an operation 302, process 300 may include decompressing a compressed image using at least one entropy decoding method on a CPU. In various implementations, the image may be compressed using a frequency-domain method (such as discrete cosine transform (DCT), fast Fourier Transform (FFT), or Walsh-Hadamard transform (WHT)), followed by compression of the DC and/or AC coefficients of the frequency-domain method using an entropy coding method. In such implementations, decompression may be then performed by applying inverse steps in the inverse order. For example, entropy decoding may be used to obtain DC and/or AC coefficients of frequency-domain, and then an inverse frequency-domain transform may be performed. In such implementations, as a result of entropy decoding performed, operation 302 may obtain AC and DC coefficients and/or full matrix of frequency-domain coefficients. In various implementations, the compressed image may be obtained in a decompression-friendly format. For example, the image may be compressed without using progressive encoding, using XYB as a color space, using Chroma-from-Luma prediction, and/or using Var-DCT mode only. In some implementations, the compressed image may be obtained as a part of a downloadable resource providing a game asset, in which the downloadable resource comprises interleaved streams for each of glTF JSON data, a mesh, and a texture of the game asset. In some implementations, the at least one entropy decoding method may comprise Huffman decoding. In other implementations, the at least one entropy decoding method may comprise asymmetrical numeral systems (ANS) decoding. In some implementations, operation 302 may be performed by a CPU the same as or similar to CPU 140 (shown in FIG. 1 and described herein).

In an operation 304, process 300 may include applying inverse frequency-domain transform (such as inverse DCT, inverse FFT, or inverse WHT) to the coefficients obtained in operation 302. In some implementations, this operation 304 may be performed on GPU. In some implementations, operation 304 may be performed by a GPU the same as or similar to GPU 150 (shown in FIG. 1 and described herein).

In an operation 306, process 300 may include recompressing the decompressed image on a GPU. In some implementations, the decompressed image may be recompressed into a DXT1 or DXT5 format. In other implementations, the decompressed image may be recompressed into a ETC1 or ETC2 format. In various implementations, the decompressed image may be recompressed using blocks the same size or a multiple of the frequency-domain blocks (such as DCT blocks, FFT blocks, or Walsh-Hadamard transform (WHT) blocks) following operation 302. For example, if DCT blocks with a size of power-of-two are used, the decompressed image may be recompressed by using power-of-two blocks such as 4×4 and 8×8 blocks. In some implementations, operation 306 may be performed by a GPU the same as or similar to GPU 150 (shown in FIG. 1 and described herein).

In an operation 308, process 300 may include writing the recompressed image directly to a texture memory of the GPU. In various implementations, writing the recompressed image directly to a texture memory of the GPU may comprise writing the recompressed image to the texture memory of the GPU without providing the recompressed image to the CPU. In some implementations, operation 308 may be performed by a GPU the same as or similar to GPU 150 (shown in FIG. 1 and described herein).

In an operation 310, process 300 may include rendering a game asset using the recompressed image written to the texture memory of the GPU. In some implementations, the computer system 110 may further comprise a second graphics processing unit (GPU). When two graphics cards are installed in the computer system and available for rendering the digital assets, a first GPU may be an internal GPU and the second GPU may be a discrete GPU. In such implementations, one GPU may be configured to facilitate hybrid decompression, as described herein, and the other GPU may be configured to render assets within a virtual scene of, for example, an online game. In some implementations, operation 310 may be performed by a GPU the same as or similar to GPU 150 (shown in FIG. 1 and described herein).

In some implementations, process 300 may further include rendering one or more additional images of a digital asset. In some implementations, process 300 may also include determining whether to use a CPU or a combination of a CPU and GPU to decompress and recompress the additional images. To determine whether to use the CPU or a combination of the CPU and GPU, characteristics of a loading queue associated with a digital asset (or game asset) may be measured (e.g., by CPU) and whether to recompress a decompressed second image on the CPU or the GPU may be determined based on the measured characteristics of the loading queue. In such implementations, the first image may comprise a first texture for a game asset and the second image may comprise a second texture for the game asset (or another game asset). In some implementations, a loading queue as referenced herein may comprise a queue of outstanding requests associated with a game asset (or set of game assets).

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be recompressed without departing from the scope of the present invention.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer readable storage medium may include read only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

The various illustrative logical blocks, modules, circuits, and algorithm steps described in connection with the embodiments disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality can be implemented in varying ways for each particular application—such as by using any combination of digital processors, analog processors, digital circuits designed to process information, central processing units, graphics processing units, microcontrollers, microprocessors, field programmable gate arrays (FPGAs), application specific integrated circuits (ASICs), a System on a Chip (SoC), and/or other mechanisms for electronically processing information—but such implementation decisions should not be interpreted as causing a departure from the scope of the present invention.

The description of the functionality provided by the different computer-readable instructions described herein is for illustrative purposes, and is not intended to be limiting, as any of instructions may provide more or less functionality than is described. For example, one or more of the instructions may be eliminated, and some or all of its functionality may be provided by other ones of the instructions. As another example, CPU 140 and GPU 150 may be programmed by one or more additional instructions that may perform some or all of the functionality attributed herein to one of the computer-readable instructions.

The various instructions described herein may be stored in electronic storage, which may comprise random access memory (RAM), read only memory (ROM), and/or other memory. In some implementations, the various instructions described herein may be stored in electronic storage of one or more components of system 100 and/or accessible via a network (e.g., via the Internet, cloud storage, and/or one or more other networks). The electronic storage may store the computer program instructions (e.g., the aforementioned instructions) to be executed by CPU 140 and GPU 150, as well as data that may be manipulated by CPU 140 and GPU 150. The electronic storage may comprise floppy disks, hard disks, optical disks, tapes, or other storage media for storing computer-executable instructions and/or data.

Although illustrated in FIG. 1 as a single component, computer system 110 and game server 210 may each include a plurality of individual components (e.g., computer devices) each programmed with at least some of the functions described herein. In this manner, some components of computer system 110 and/or associated client computing device(s) may perform some functions while other components may perform other functions, as would be appreciated. Furthermore, it should be appreciated that although the various instructions are illustrated in FIG. 1 as being co-located within a single processing unit, in implementations in which CPU 140, GPU 150, and/or processor(s) 212 include multiple processing units, one or more instructions may be executed remotely from the other instructions.

One or more components of system 100 may communicate with each other through hard-wired communication, wireless communication, or both. In various implementations, one or more components of system 100 may communicate with each other through a network. For example, client computer system 110 and/or game server 210 may wirelessly communicate with electronic storage 130. By way of non-limiting example, wireless communication may include one or more of radio communication, Bluetooth communication, Wi-Fi communication, cellular communication, infrared communication, or other wireless communication. Other types of communications are contemplated by the present disclosure.

Although client computer system 110, electronic storage 130, and game server 210 are shown to be connected to interface 102 in FIG. 1, any communication medium may be used to facilitate interaction between any components of system 100. For example, as referred to herein, interface 102 may comprise a network via which client computer system 110 may transmit packets or otherwise communicate with game server 210. In some implementations, the connections forming the network represented by interface 102 may include Asymmetric Digital Subscriber Line (ADSL), Symmetric Digital Subscriber Line (SDSL), cable, 3G, 4G, LTE, Ethernet, or any other existing or future developed systems and/or methods of communication with similar functionalities. In some implementations, one or multiple connections may be used to facilitate communication (e.g., transmit packets) between client computer system 110 and game server 210. Indeed, while described herein as a single interface 102 for simplicity, interface 102 may include one or multiple physical and/or virtual interfaces via which packets may be sent from client computer system 110 to game server 210, and vice versa. For example, multiple connections forming a Local Area Network (LAN), Intranet, or Internet may be used to facilitate communication between client computer system 110 and game server 210.

Reference in this specification to “one implementation”, “an implementation”, “some implementations”, “various implementations”, “certain implementations”, “other implementations”, “one series of implementations”, or the like means that a particular feature, design, structure, or characteristic described in connection with the implementation is included in at least one implementation of the disclosure. The appearances of, for example, the phrase “in one implementation” or “in an implementation” in various places in the specification are not necessarily all referring to the same implementation, nor are separate or alternative implementations mutually exclusive of other implementations. Moreover, whether or not there is express reference to an “implementation” or the like, various features are described, which may be variously combined and included in some implementations, but also variously omitted in other implementations. Similarly, various features are described that may be preferences or requirements for some implementations, but not other implementations.

The language used herein has been principally selected for readability and instructional purposes, and it may not have been selected to delineate or circumscribe the inventive subject matter. Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A computer-implemented method of performing hybrid decompression of images compressed using compression based on a frequency-domain transform, the method being implemented on a computer system comprising at least a central processing unit (CPU) and a graphics processing unit (GPU), the method comprising:
decompressing, by the CPU, a compressed image using at least one entropy decoding method; and
applying, by the GPU, inverse frequency-domain transform to coefficients obtained during decompression of the compressed image.

2. The computer-implemented method of claim 1, the method further comprising:
recompressing, by the GPU, the decompressed image; and
writing, by the GPU, the recompressed image directly to a texture memory of the GPU.

3. The computer-implemented method of claim 1, wherein the at least one entropy decoding method comprises Huffman decoding.

4. The computer-implemented method of claim 1, wherein the at least one entropy decoding method comprises an asymmetrical numeral systems (ANS) decoding method.

5. The computer-implemented method of claim 4, wherein the asymmetrical numeral systems (ANS) decoding method comprises range asymmetric numeral systems (rANS) decoding or tabled asymmetrical numeral systems (tANS) and finite state entropy (FSE) decoding.

6. The computer-implemented method of claim 2, wherein the decompressed image is recompressed into a DXT1 or DXT5 format.

7. The computer-implemented method of claim 2, wherein the decompressed image is recompressed into a ETC1 or ETC2 format.

8. The computer-implemented method of claim 2, wherein writing the recompressed image directly to the texture memory of the GPU comprises writing the recompressed image to the texture memory of the GPU without providing the recompressed image to the CPU.

9. The computer-implemented method of claim 2, the method further comprising:
rendering, by the GPU, the game asset using the recompressed image written to the texture memory of the GPU.

10. The computer-implemented method of claim 9, wherein the compressed image comprises a first texture of a game asset, the method further comprising:
decompressing, by the CPU, a second texture of the game asset using at least one entropy decoding method;
recompressing, by the CPU, the decompressed second texture; and
writing, by the CPU, the recompressed second texture to the texture memory of the GPU.

11. The computer-implemented method of claim 10, the method further comprising:
measuring, by the CPU, characteristics of a loading queue associated with the game asset; and
determining, by the CPU, whether to recompress the decompressed second texture on the CPU or the GPU based on the measured characteristics of the loading queue.

12. The computer-implemented method of claim 11, wherein the loading queue comprises a queue of outstanding requests associated with the game asset.

13. The computer-implemented method of claim 2, wherein the computer system comprises at least a second graphics processing unit (GPU), the method further comprising:
rendering, by the second GPU, the game asset using the recompressed image written to the texture memory of the GPU.

14. The computer-implemented method of claim 13, wherein rendering the game asset by the second GPU comprises:
providing, by the GPU, a decompressed third texture of a game asset from the GPU to the CPU;
writing, by the CPU, the decompressed third texture of the game asset to the texture memory of the second GPU; and
rendering, by the second GPU, the game asset using the decompressed third texture written to the texture memory of the second GPU.

15. The computer-implemented method of claim 1, the method further comprising:
obtaining, by the CPU, the compressed image, wherein the compressed image is obtained in a decompression-friendly format.

16. The computer-implemented method of claim 15, wherein the image is compressed without using progressive encoding.

17. The computer-implemented method of claim 15, wherein the image is compressed using XYB as a color space and/or using Chroma-from-Luma prediction.

18. The computer-implemented method of claim 15, wherein the image is compressed using Var-DCT mode only.

19. The computer-implemented method of claim 15, wherein the compressed image is obtained as a part of a downloadable resource providing a game asset, wherein the downloadable resource comprises interleaved streams for each of glTF JSON data, a mesh, and a texture of the game asset.

20. The computer-implemented method of claim 1, wherein the frequency-domain transform comprises discrete cosine transform (DCT), and wherein the inverse frequency-domain transform comprises inverse DCT.

21. The computer-implemented method of claim 1, wherein the frequency-domain transform comprises Fast Fourier Transform (FFT), and wherein the inverse frequency-domain transform comprises inverse FFT.

22. The computer-implemented method of claim 1, wherein the frequency-domain transform comprises Walsh-Hadamard Transform (WHT), and wherein the inverse frequency-domain transform comprises inverse WHT.

23. A system for performing hybrid decompression of images compressed using compression based on a frequency-domain transform, the system comprising:
a central processing unit (CPU) configured by computer readable instructions to decompress a compressed image using at least one entropy decoding method; and
a graphics processing unit (GPU) configured by computer readable instructions to apply inverse frequency-domain transform to coefficients obtained during decompression of the compressed image.

24. The system of claim 23, wherein the GPU is further configured by computer readable instructions to:
recompress the decompressed image; and
write the recompressed image directly to a texture memory of the GPU.

25. The system of claim 23, wherein the at least one entropy decoding method comprises Huffman decoding.

26. The system of claim 23, wherein the at least one entropy decoding method comprises an asymmetrical numeral systems (ANS) decoding method.

27. The system of claim 26, wherein the asymmetrical numeral systems (ANS) decoding method comprises range asymmetric numeral systems (rANS) decoding or tabled asymmetrical numeral systems (tANS) and finite state entropy (FSE) decoding.

28. The system of claim 24, wherein the decompressed image is recompressed into a DXT1 or DXT5 format.

29. The system of claim 24, wherein the decompressed image is recompressed into a ETC1 or ETC2 format.

30. The system of claim 24, wherein to write the recompressed image directly to the texture memory of the GPU, the GPU is further configured by computer readable instructions to write the recompressed image to the texture memory of the GPU without providing the recompressed image to the CPU.

31. The system of claim 24, wherein the GPU is further configured by computer readable instructions to render the game asset using the recompressed image written to the texture memory of the GPU.

32. The system of claim 31, wherein the compressed image comprises a first texture of a game asset, wherein the CPU is further configured by computer readable instructions to:
decompress a second texture of the game asset using at least one entropy decoding method;
recompress the decompressed second texture; and
write the recompressed second texture to the texture memory of the GPU.

33. The system of claim 32, wherein the CPU is further configured by computer readable instructions to:
measure characteristics of a loading queue associated with the game asset; and
determine whether to recompress the decompressed second texture on the CPU or the GPU based on the measured characteristics of the loading queue.

34. The system of claim 33, wherein the loading queue comprises a queue of outstanding requests associated with the game asset.

35. The system of claim 24, the system further comprising at least a second graphics processing unit (GPU) configured by computer readable instructions to render the game asset using the recompressed image written to the texture memory of the GPU.

36. The system of claim 35, wherein to render the game asset by the second GPU, the GPU is configured by computer readable instructions to provide a decompressed third texture of a game asset from the to the CPU, the CPU is configured by computer readable instructions to write the decompressed third texture of the game asset to the texture memory of the second GPU, and the second GPU is configured by computer readable instructions to render the game asset using the decompressed third texture written to the texture memory of the second GPU.

37. The system of claim 23, wherein the CPU is further configured by computer readable instructions to obtain the compressed image, wherein the compressed image is obtained in a decompression-friendly format.

38. The system of claim 37, wherein the image is compressed without using progressive encoding.

39. The system of claim 37, wherein the image is compressed using XYB as a color space and/or using Chroma-from-Luma prediction.

40. The system of claim 37, wherein the image is compressed using Var-DCT mode only.

41. The system of claim 37, wherein the compressed image is obtained as a part of a downloadable resource providing a game asset, wherein the downloadable resource comprises interleaved streams for each of glTF JSON data, a mesh, and a texture of the game asset.

42. The system of claim 23, wherein the frequency-domain transform comprises discrete cosine transform (DCT), and wherein the inverse frequency-domain transform comprises inverse DCT.

43. The system of claim 23, wherein the frequency-domain transform comprises Fast Fourier Transform (FFT), and wherein the inverse frequency-domain transform comprises inverse FFT.

44. The system of claim 23, wherein the frequency-domain transform comprises Walsh-Hadamard Transform (WHT), and wherein the inverse frequency-domain transform comprises inverse WHT.
